(19) United States
(12) Patent Application Publication
(10) Pub. No.: US 2025/0346072 A1
(43) Pub. Date: Nov. 13, 2025

(54) VEHICLE WHEEL END ASSEMBLY

(71) Applicant: AKTIEBOLAGET SKF, GOTEBORG (SE)

(72) Inventors: Volker WENDT, Üchtelhausen/Zell (DE); Libin ZHANG, Kunshan (CN); Rico DITTMAR, Schweinfurt (DE)

(21) Appl. No.: 19/192,962

(22) Filed: Apr. 29, 2025

(30) Foreign Application Priority Data
May 7, 2024 (CN) 202410552390.7

(51) Int. Cl. B60B 27/00; F16C 19/38

(52) U.S. Cl. CPC B60B 27/001; F16C 19/386; F16C 2326/02

(57) ABSTRACT

A vehicle wheel end sub-assembly includes a wheel bearing unit configured to be assembled on a vehicle stub axle, and a wheel adapter rotatably supported on the stub axle via the wheel bearing unit. The wheel bearing unit includes two rows of bearings and an outer ring integral member, and the wheel adapter is releasably connected to the outer ring integral member at at least one screw fastening point by at least one threaded fastener and is configured to connect a brake disk to a wheel. The at least one screw fastening point is located at a radial periphery of the outer ring integral member at a location axially spaced from an outboard end face of the outer ring integral member.

### CROSS-REFERENCE

This application claims priority to Chinese patent application no. 202410552390.7 filed on May 7, 2024, the contents of which are fully incorporated herein by reference.

### TECHNOLOGICAL FIELD

The present disclosure relates to a vehicle wheel end assembly, especially a wheel end assembly for a driven wheel and a non-driven wheel of a truck.

### BACKGROUND

FIG. 1 shows a cross-sectional view of a conventional wheel end assembly used in truck driven wheels (hereinafter abbreviated as “scheme 1”). The wheel end assembly 1 comprises a wheel bearing unit 3 capable of being assembled on a vehicle stub axle 2 and a wheel hub 34 obtaining rotational support on the stub axle through the wheel bearing unit. The wheel bearing unit 3 comprises at least two rows of rolling bearings, typically a pair of tapered roller bearings 31, 32, assembled on the stub axle 2 at predetermined axial intervals. The wheel hub 34 is fixedly assembled on bearing outer ring 31a, 32a, thereby rotating synchronously with the latter. The wheel hub 34 is also formed integrally with a wheel adaptation flange 4 for connecting vehicle wheels (the Figure shows two wheels in parallel) 41 and a brake disk 42. When the brake disk 42 needs to be serviced, the vehicle wheels 41 must first be disassembled from the flange 4, and then the wheel hub 34, which is assembled with the brake disk 42 and comprises two rows of bearings 31 and 32, is disassembled from the stub axle 2.

In the process of disassembly described above, the wheel hub 34 may be inclined unavoidably when the outboard bearing 31 is the first to be removed from the stub axle 2, thereby forming an angle with the horizontal stub axle, since the wheel hub 34 that connects the brake disk 42 and comprises two rows of bearings 31 and 32 is very heavy. Due to the amplification effect of the lever, this inclination may cause a huge impact on the inboard bearing 32 (on the right side of the Figure), so that some rolling bodies of the inboard bearing 32 are pressed into the raceway, forming pits on the raceway. When the inboard bearing 32 is put into service again, material spalling begins to occur on the damaged raceway under the action of the operating load. Typically, at around 10,000 kilometers after the maintenance of the brake disk, the damaged bearing will fail.

In order to address the above problems, the applicant proposed an improved technical solution (hereinafter abbreviated as “scheme 2”) in the patent application WO 2022/008272 A1 filed on Jun. 28, 2021 (a family member of US 2023/265881). In the scheme 2, as shown in FIGS. 2A and 2B, the wheel adaptation flange 4 that had been integrally formed on the wheel hub 34 in the scheme 1 is replaced with an independent wheel adapter (hereinafter abbreviated as “adapter”, still using the reference numeral 4), and the adapter 4 is able to be assembled on a common outer ring 33 of the two rows of bearings 31 and 32 in a detachable manner through its inner circumferential flange 45. Then, when the brake disk 42 needs to be serviced, it is only necessary to disassemble the adapter 4 from the common outer ring 33 and take it out, and it is not necessary to disassemble the whole wheel hub 34 along with all bearings 31 and 32 from the stub axle 2 to realize the maintenance as in scheme 1. In other words, the maintenance of the brake disk 42 in the scheme 2 is not conditional on the removal of the whole wheel bearing unit 3. This makes the bearings 31 and 32 as precision components be preserved and theoretically may always be in a stable state after the original factory commissioning, thereby avoiding risks which can be caused by being subjected to any unnecessary disassembly and reassembly. More than that, the individually disassembled and assembled adapter makes maintenance of the brake disk easy.

However, the scheme 2 has its own problems, especially, the weight of the “common outer ring+wheel adapter” is much larger than that of the “wheel hub+wheel adapter flange” in the scheme 1. This is because the screw fastening point (abbreviated as “screwing point”) between the adapter 4 and the common outer ring 33 is still located on the outboard end face 33a of the common outer ring 33, like the wheel adapter flange 4 and the wheel hub 34 shown in FIG. 1. This screwing point is axially far away from a wheel load action line X, thus both of the adapter 4 and the common outer ring 33 must be configured to have a wall thickness of sufficient radial dimension on a section of length between the screwing point and the wheel load action line X, and may even have to employ stiffener structures 47, 48, in order to achieve the structural strength required to carry the wheel load. This is the root reason of the increase in the weight and cost of the wheel end assembly in the scheme 2.

It would therefore be desirable to provide a wheel end assembly that facilitates the maintenance of the brake disk without increasing the weight of the vehicle body.

### SUMMARY

In order to solve the above-mentioned technical problems, the present disclosure provides a vehicle wheel end assembly comprising a wheel bearing unit configured to be assembled on a vehicle stub axle and a wheel adapter to be rotationally supported on the stub axle via the wheel bearing unit. The wheel bearing unit comprises at least two rows of bearings and a bearing integral outer ring member configured to rotate synchronously with the bearing outer rings of the at least two rows of bearings. The adapter is a detachable member independent of the outer ring integral member for connecting the wheel and the brake disk. At least in a state of connection of the brake disk, the adapter is capable of being fastened on the outer ring integral member or of being removed from the latter by means of screws. A screw fastening point between the adapter and the outer ring integral member is located at radial outside of the outer ring integral member at a location axially spaced from an outboard end face of the outer ring integral member.

By moving the screwing point from the outboard end face of the outer ring integral member to a radial periphery of the outer ring integral member, especially axially approaching a wheel load action line X, the aforementioned weight increasing effect caused by an excessive axial spacing between the screw fastening point and the wheel load action line may be effectively avoided. Based on the improved technical scheme described above, the present disclosure not only retains the original advantages of the scheme 2 (that is, allowing the wheel adapter to be disassembled independently, avoiding the huge risk due to bearing disassembly and assembly), but also reduces the overall weight of the wheel end assembly to a weight roughly equivalent to that of the wheel end assembly according to scheme 1.

Various embodiments and beneficial technical effects of the present disclosure are described in detail below with reference to the accompanying drawings.

### BRIEF DESCRIPTION OF THE DRAWINGS

FIG. 1 is a schematic cross-sectional view of a conventional wheel end assembly (scheme 1) used in truck driven wheels.

FIG. 2A is a schematic cross-sectional view of the wheel end assembly in another conventional wheel end assembly (scheme 2).

FIG. 2B is a perspective view of the wheel end assembly of FIG. 2.

FIG. 3A is a schematic cross-sectional view of a wheel end assembly according to an embodiment of the present disclosure configured for use with a driven wheel of a vehicle.

FIG. 3B is a perspective view of a wheel end assembly of the present disclosure configured for use with a driven wheel of the vehicle.

FIG. 3C is a perspective view of the wheel bearing unit of FIG. 3B.

FIG. 4A is a schematic cross-sectional view of a wheel end assembly according to an embodiment of the present disclosure configured for use with a non-driven wheel of the vehicle.

FIG. 4B is a perspective structure view of a wheel end assembly according to an embodiment of the present disclosure configured for use with a non-driven wheel of the vehicle.

### DETAILED DESCRIPTION

In the following description, identical or similar reference characters are always used to denote the same or similar components. Terms indicating directions, for example, “axial”, “radial” and “circumferential (direction)”, each refer to the axial, radial and circumferential (direction) of the component being described, unless otherwise defined or specified, In addition, “inboard” refers to a direction approaching a center line of a vehicle body and corresponds to the left side of each cross-section, and “outboard” refers to a direction away from the center line of the vehicle body and corresponds to the right side of each cross-section.

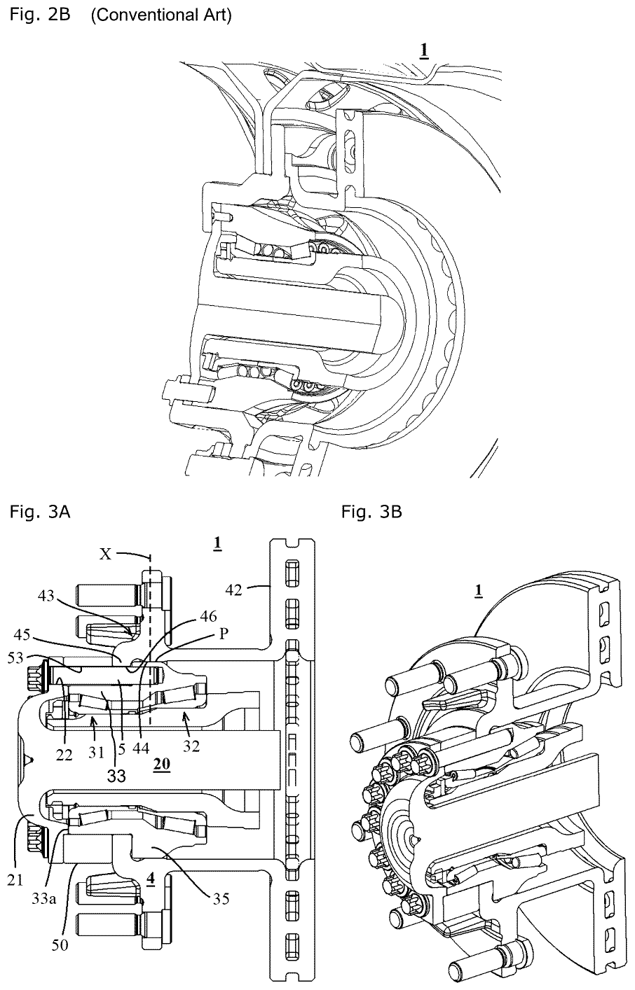

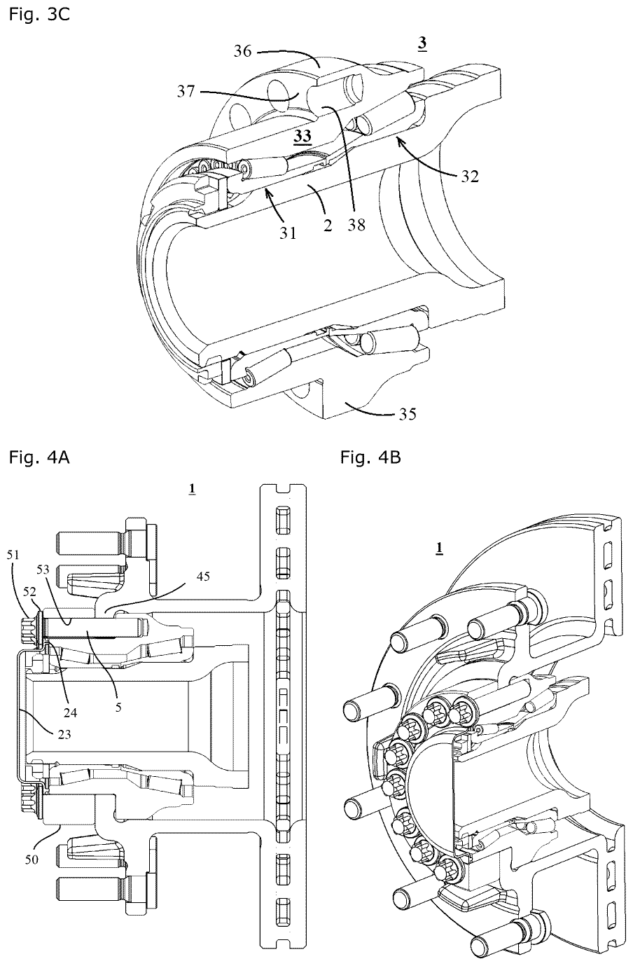

FIGS. 3A and 3B show a schematic cross-sectional view and a perspective structure view, respectively, of an improved wheel end assembly when it is used for a driven wheel of a vehicle,. In the illustrated scheme, a wheel adapter 4 is assembled on a common outer ring 33 of two rows of bearings 31 and 32 and is connected to the common outer ring 33 by a plurality of threaded fasteners 5, which may be screws, that extending through an inner circumferential flange 45 of the wheel adapter 4. Compared with FIGS. 2A and 2B, it can be seen that a screwing point between the inner circumferential flange 45 and the common outer ring 33 has been moved from an outboard end face 33a of the common outer ring 33 in the previous scheme 2 to a radial periphery of the common outer ring 33 in the current technical scheme. As a preferred embodiment, the screwing point may be as close as possible to a wheel load action line X, in order to shorten an axial distance between the two.

It is necessary to point out that, in the present disclosure, the screwing point is an abstract concept, and does not refer to an entire range of a length of the screw, but refers to a specific position of an interface between bound members in an axial direction of the screw. For example, in the scheme 2 shown in FIGS. 2A and 2B, the screwing point between an outer circumferential flange 21 of a driver shaft 20 and the common outer ring 33 is located on an outboard end face 33a of the common outer ring 33, and the screwing point between an inner circumferential flange 45 of an adapter 4 and the circumferential flange 21 of the driver shaft 20 is located on a contact face between the two.

FIG. 3C shows a perspective structure of the wheel bearing unit in FIG. 3B. In the illustrated scheme, the common outer ring 33 of bearings is formed with a step-shaped circumferential protrusion 35 which is used to constitute a support for supporting the adapter 4. The outer ring and the circumferential protrusion 35 formed integrally with the common outer ring 33 together form an “outer ring integral member” as that phrase is used herein. That is, an outer ring integral member is a bearing outer ring and any integral structures that might not be present on a conventional bearing outer ring. The common outer ring 33 has the greatest radial thickness at the place where the support 35 is located, for carrying a wheel load that the adapter 4 transfers. Specifically, the support 35 is formed with a circumferential radial outer face 36 and an outboard end face 37 for providing radial support and axial support, respectively, for the adapter 4. In addition, the support 35 also has threaded holes 38 formed on a side of the outboard end face 37 thereof suitable for receiving a threaded fastener such as a screw. It can be seen from FIGS. 3A and 3B, that a base 43 matching the support 35 is formed on the adapter 4. The base 43 comprises a circumferential radial inner face 44 supporting the radial outer face 36 of the support and an inner circumferential flange 45 abutting the outboard end face 37 of the support. Screwing holes 46, corresponding to the threaded holes 38 of the support, are formed on the inner circumferential flange 45 of the base, allowing the screws to pass through them to be screwed into the threaded holes 38, thereby fastening the base 43 and the support 35 together.

In the fitting between the base and the support described above, a radial load bearing face P is formed between the radial inner face 44 of the base and the radial outer face 36 of the support. As a preferred embodiment, the support 35 together with the load bearing face P is axially biased as a whole towards the inboard side, thereby allowing the outboard bearing 31 to employ rolling bodies of a smaller dimension than the inboard bearing 32. This design allows the common outer ring 33 to employ a wall thickness of the smallest practicable radial dimension in the outboard section of the wheel load action line X, thereby achieving the purpose of further weight reduction.

In the specific embodiment shown in FIGS. 3A and 3B, a set of screws fasten the driver shaft 20, the common outer ring 33 and the adapter 4 together by means of a spacer ring 50. The spacer ring 50 is an annular member, with through holes 53 formed internally that allow screws to pass therethrough, and when placed between the outer circumferential flange 21 of the driver shaft 20 and the inner circumferential flange 45 of the adapter 4, the latter two may be provided with axial support required to resist screws fastening. It is not difficult to see that the existence of spacer ring 50 creates a condition for connecting the driver shaft 20, the common outer ring 33 and the adapter 4 into one by employing the same set of screws 5. As a possible alternative design, the above purpose may also be achieved by employing two sets of screws (not illustrated). For example, the support 35 of the common outer ring 33 and the base 43 of the adapter 4 may be fastened using a first set of screws, and the outer circumferential flange 21 of the driver shaft 20 and the outboard end face 33a of the common outer ring 33 may be fastened using a second set of screws. Compared with the technical scheme that only employs one set of screws shown in FIGS. 3A and 3B, in the alternative scheme, the number of parts is greater and the disassembly and assembly may be slightly more complicated due to the use of a additional set of screws, but the purpose of the present disclosure may still be achieved.

FIGS. 4A and 4B show a schematic cross-sectional view and a three-dimensional perspective view of the improved wheel end assembly of the present disclosure when it is used for a non-driven wheel of the vehicle. Since the stub axle 2 of the non-driven wheel of the vehicle does not include a driver shaft, the screws 5 only need to pass through the spacer ring 50, the inner circumferential flange 45 of the adapter 4 and the support 35 of the common outer ring 33 in order from the outboard side, to fasten the common outer ring 33 and the adapter 4 together. It is necessary to point out that, the wheel end assembly 1 used for the non-driven wheel usually also comprises an end cap 23 for enclosing the stub axle 2 to prevent external contaminants from entering the stub axle 2 and the bearing unit 3. In the embodiment shown in FIGS. 4A and 4B, the screws 5 also utilize their screw heads 51 and/or screw washers 52 to press a radial outer edge 24 of the end cap 23 against the outboard end face 33a of the common outer ring 33 while passing through the spacer ring 50. Alternatively, the end cap 23 may also have screw holes (not shown) formed on its radial outer edge 24 to allow the screws to pass through them. In this case, the screws 5 may pass through the screw holes of the radial outer edge 24 from the outboard side and press the end cap 23 against the outboard end faces of the spacer ring 50 and/or the common outer ring 33, similar to the situation in which the screws 5 pass through the outer circumferential flange 21 of driver shaft 20 shown in FIGS. 3A and 3B.

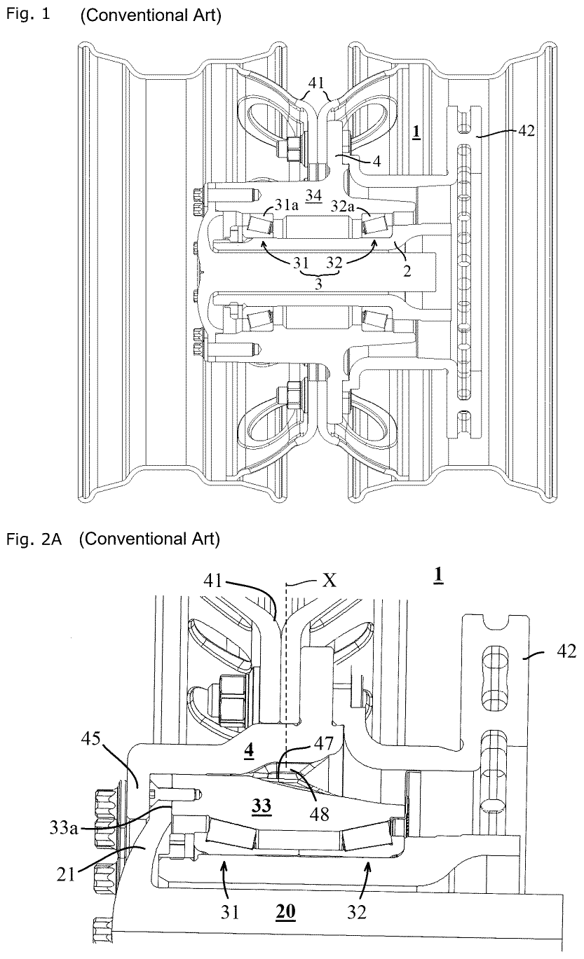

It is necessary to point out that, in the wheel end assembly 1 shown in FIGS. 3A-C and 4A and 4B, the adapter 4 is assembled on the common outer ring 33 of the two rows of bearings 31 and 32, but is not assembled on a wheel hub 34 as in the situation shown in FIG. 1. It is not difficult to understand that, the purpose of the present disclosure may still be achieved, even if the adapter 4 that is assembled on the common outer ring 33 in FIGS. 3A-C and 4A and 4B, is assembled on the wheel hub 34 shown in FIG. 1. This is because, in the scheme 1, the wheel hub 34 is fixedly assembled on the bearing outer ring 31 and 32, and has actually formed an integral structure with the latter, so that the wheel hub 34 may completely rotate synchronously with it. Thus it can be seen that, regardless of the bearing outer ring itself, such as the common outer ring 33 shown in FIGS. 3 and 4, or other member that is fixedly assembled on the bearing outer ring, such as the wheel hub 34 shown in FIG. 1, it may be provided for connecting the adapter 4. In other words, in the present disclosure, the outer rings of the at least two rows of bearings, or any other member fixedly assembled on the bearing outer ring, may each achieve the purpose of the present disclosure as long as they are provided to suitably to connect wheel adapter. In view of this, this bearing outer ring or other member configured on the bearing outer ring is uniformly defined as the “bearing outer ring integral member” (referred to as the “outer ring integral member”).

The vehicle wheel end assembly described above is not limited by the specific embodiments and more general technical solutions will be subject to the limitations of the accompanying claims. Any modifications and improvements to the present invention are within the scope of protection of the present invention, provided they conform to the limitations of the accompanying claims.

What is claimed is:

1. A vehicle wheel end sub-assembly comprising:
a wheel bearing unit configured to be assembled on a vehicle stub axle, and
a wheel adapter rotatably supported on the stub axle via the wheel bearing unit,
wherein the wheel bearing unit comprises two rows of bearings and an outer ring integral member,
wherein the wheel adapter is releasably connected to the outer ring integral member at at least one screw fastening point by at least one threaded fastener and is configured to connect a brake disk to a wheel, and
wherein the at least one screw fastening point is located at a radial periphery of the outer ring integral member at a location axially spaced from an outboard end face of the outer ring integral member.

2. The vehicle wheel end sub-assembly according to claim 1,
wherein the outer ring integral member is a common outer ring of the two rows of bearings.

3. The vehicle wheel end sub-assembly according to claim 1,
wherein the outer ring integral member is a common outer ring of the two rows of bearings or other members, including but not limited to a wheel hub, fixedly assembled on the bearing outer ring of the at least two rows of bearings and capable of rotating synchronously therewith.

4. The vehicle wheel end sub-assembly as claimed in claim 2,
wherein the outer ring integral member includes a protrusion having an outboard end face,
wherein the adapter includes a base in contact with the outboard end face of the protrusion, and
wherein the screw fastening point is located at the junction of the outboard end face and the base of the adapter.

5. The vehicle wheel end sub-assembly as claimed in claim 4,
wherein the protrusion has a circumferential radial outer surface radially contacting a radially inner surface of the adapter,
wherein the outboard end face of the protrusion includes a plurality of threaded holes,
wherein the base includes an inner circumferential flange having screw holes aligned with the threaded holes of the protrusion, and
wherein the outboard end face of the outer ring integral member axially contacts the flange.

6. The vehicle wheel end sub-assembly as claimed in claim 5,
wherein a radial load bearing face is formed between the circumferential radial inner face of the base and the circumferential radial outer surface of the protrusion, the load bearing face being axially biased as a whole towards an inboard side of the outer ring integral member, and
wherein the rolling bodies of the outboard one of the two bearing are smaller than the rolling bodies of the inboard one of the two bearings.

7. An assembly comprising,
the vehicle wheel end sub-assembly according to claim 6,
the vehicle stub axle,
a driver shaft having a first portion in the stub axle and a second portion outside the stub axle, the second portion including a radially outer circumferential flange having through openings, and
a spacer ring between the outer circumferential flange and the base,
wherein the plurality of threaded fasteners extend through the through openings in the radially outer circumferential flange and through the screw holes of the flange and into the threaded holes of the protrusion.

8. An assembly comprising:
the vehicle wheel end sub-assembly according to claim 6,
the vehicle stub axle,
an end cap covering an outboard end of the stub axle, the end cap including a plurality of through openings,
a spacer ring between the end cap and the base,
wherein the plurality of threaded fasteners extend through the through openings in the end cap and through the screw openings of the flange and into the threaded openings of the protrusion.

9. The assembly according to claim 8,
wherein the threaded fasteners include heads in contact with the end cap.

10. The vehicle wheel end sub-assembly according to claim 6,
wherein the spacer ring is made of a material lighter than bearing steel.

11. The vehicle wheel end sub-assembly according to claim 6,
wherein the spacer ring is made of aluminum or an aluminum alloy.

12. The vehicle wheel end sub-assembly according to claim 6,
wherein the flange is located axially between the two rows of bearings.

13. The vehicle wheel end sub-assembly according to claim 6,
wherein the at least one screw fastening point is located axially between the two rows of bearings.

14. The vehicle wheel end sub-assembly according to claim 1,
wherein the at least one screw fastening point is located axially between the two rows of bearings.
